SEQUENCE LISTING (3 sequences)

SEQ ID NO: 1 - DNA, 15 bp, Artificial Sequence
  Exemplary Sequence
atgctggctaatgct

SEQ ID NO: 2 - DNA, 20 bp, Artificial Sequence
  Exemplary sequence
gatttctatagttgagtcat

SEQ ID NO: 3 - DNA, 18 bp, Artificial Sequence
  Exemplary Sequence
ttagtacgttagtgtcgt

(19) United States
(12) Patent Application Publication
(10) Pub. No.: US 2012/0089338 A1
(43) Pub. Date: Apr. 12, 2012

(54) COMPUTER IMPLEMENTED METHOD FOR INDEXING REFERENCE GENOME

(75) Inventor: Chantal Roth, Kallnach (CH)

(73) Assignee: LIFE TECHNOLOGIES CORPORATION, Carlsbad, CA (US)

(21) Appl. No.: 13/203,945

(22) PCT Filed: Mar. 15, 2010
(86) PCT No.: PCT/US2010/000772

§ 371 Date: Nov. 28, 2011

Related U.S. Application Data
(60) Provisional application No. 61/160,132, filed on Mar. 13, 2009.

(51) Int. Cl. G06F 19/18

(52) U.S. Cl. 702/19

(57) ABSTRACT

A method for indexing a reference genome is provided. The method includes selecting a reference genome to index, calculating a first minimum index region size, assigning a first position number to a first index region of the reference genome, assigning a second position number to a second index region of the reference genome, and storing the association of the first and second position numbers to index regions in a hash table. The size of the first index region can be greater than or equal to the first minimum index region size. The second index region can overlap with at least one base included in the first index region. The first minimum index region size can be calculated based on the reference genome size. In yet other embodiments of the present teachings, a method for mapping a sequence read to a reference genome is provided wherein a sequence read is compared to the index regions stored in the indexing hash table, and the sequence read is mapped to and aligned against a location on the reference genome. Systems configured to carry out the methods are also provided.

### CROSS-REFERENCE TO RELATED APPLICATION

The present application claims the priority benefit of U.S. Provisional Patent Application No. 61/160,132, filed Mar. 13, 2009, for “System and Method for Genome Assembly,” which is incorporated herein in its entirety by reference.

### FIELD

The present teachings relate to methods for indexing a reference genome.

### BACKGROUND

Existing assembly tools use fast overlappers that quickly filter out pairs of Sanger reads that cannot result in statistically significant alignments. These fast overlappers rely on the assumption that the overlapping reads share a long k-mer, for example, a sequence 25 bases in length. While this condition holds in case of Sanger reads, it is unlikely to hold for reads that have gaps, which cause a lack of long k-mers. For example, some methods of single molecule nucleotide sensing that use detecting light emissions from quantum dot fluorescencing have problems in that the quantum dot blinks on and off while a polymerase continues to add nucleotides to a DNA sequence being replicated. Thus, due to the blinking of the quantum dot, there are gaps in the sensed reads, referred to herein as StarLight or SL reads. Thus, existing ways to assemble a genome are not applicable to assembling a genome from SL reads.

A need exists for a better method for indexing a reference genome and for a better method of mapping and aligning sequence reads to a reference genome.

### SUMMARY

According to various embodiments, a method for indexing a reference genome is provided. The method comprises selecting a reference genome to index, calculating a first minimum index region size, assigning a first position number to a first sequence of nucleic acids that corresponds to a first index region of the reference genome, assigning a second position number to a second sequence of nucleic acids that corresponds to a second index region of the reference genome, and storing the association of the first and second position numbers to index regions in a hash table. Each position number can be a unique identifier for its respective sequence of nucleic acids. The size of the first index region can be greater than or equal to the first minimum index region size. The second index region can overlap with at least one base included in the first index region. The calculating a first minimum index region size can be based on the reference genome size, for example, based on the fourth log of the total number of bases in the reference genome. A system for carrying out a method for indexing a reference genome is also provided.

In yet other embodiments of the present teachings, a method for mapping a sequence read to a reference genome is provided wherein a first sequence read is compared to the index regions stored in the indexing hash table, to identify matches. All candidate locations are identified on the reference genome where the sequence read can be mapped against. Each candidate location can contain at least two index regions that match corresponding regions on the sequence read. A probability score is then calculated for all identified candidate locations. The sequence read is then mapped to the candidate location with the highest probability score, and aligned against the candidate location. A system for carrying out a method for mapping a sequence read to a reference genome is also provided.

In some embodiments, the present teachings provide methods and systems for determining the nature of information gaps in sequence reads by using parameters and other considerations discussed herein. In some embodiments, longer k-mers are mapped to the reference genome and a method of k-mer patching is provided that uses smaller k-mers to fill in gaps in regions mapped to the reference genome. In some embodiments, a wildcard can be assigned as described herein, to determine the best mapping location from among a plurality of candidate locations.

### BRIEF DESCRIPTION OF THE DRAWINGS

The accompanying drawings, which are incorporated into and constitute a part of the specification, illustrate specific embodiments of the invention, and taken in conjunction with the detailed description of the specific embodiments, serve to explain the principles of the invention.

FIG. 1 is a flow chart showing the various steps involved with a method of indexing a reference genome, according to various embodiments of the present teachings.

FIG. 2 is a flow chart showing the various steps involved with a method of mapping a sequence read to a reference genome, according to various embodiments of the present teachings.

FIG. 3 is a schematic diagram of a system according to various embodiments of the present teachings, comprising an input for sequence reads, an output for outputting an assembled genome, and a genome assembly analytics core comprising various engines modules, an indexing hash table, and a consensus sequence determination module.

FIG. 4 is a schematic diagram of a system for mapping sequence reads to a reference genome, according to various embodiments of the present teachings.

FIG. 5 shows a human genome suffix array that can be used according to various embodiments of the present teachings.

FIG. 6 shows a method of mapping according to the present teachings wherein two k-mers are mapped to a location 11 of a reference genome and one k-mer is mapped to a location 12 of the reference genome.

FIG. 7 is a matrix computed to determine optimal alignment for dynamic programming of two reads of length m, according to various embodiments of the present teachings.

FIG. 8 is a matrix computed to determine optimal alignment for dynamic programming of two reads of length m, where one location of an entire alignment has been fixed, in relation to the matrix shown in FIG. 7, according to various embodiments of the present teachings.

FIG. 9 is a four-step process flow diagram demonstrating k-mer patching according to various embodiments of the present teachings.

FIG. 10 is a data structure for a method to retrieve and compute the start/end positions of DNA-pieces from a read to compute alignments according to various embodiments of the present teachings.

FIG. 11 depicts a method according to various embodiments of the present teachings wherein a sliding algorithm is slid over an entire genome that has mapped reads.

### DETAILED DESCRIPTION

The following detailed description serves to explain the principles of the present teachings. The present teachings are susceptible to modifications and alternative forms and are not limited to the particular forms disclosed herein. The present teachings cover modifications, equivalents, and alternatives.

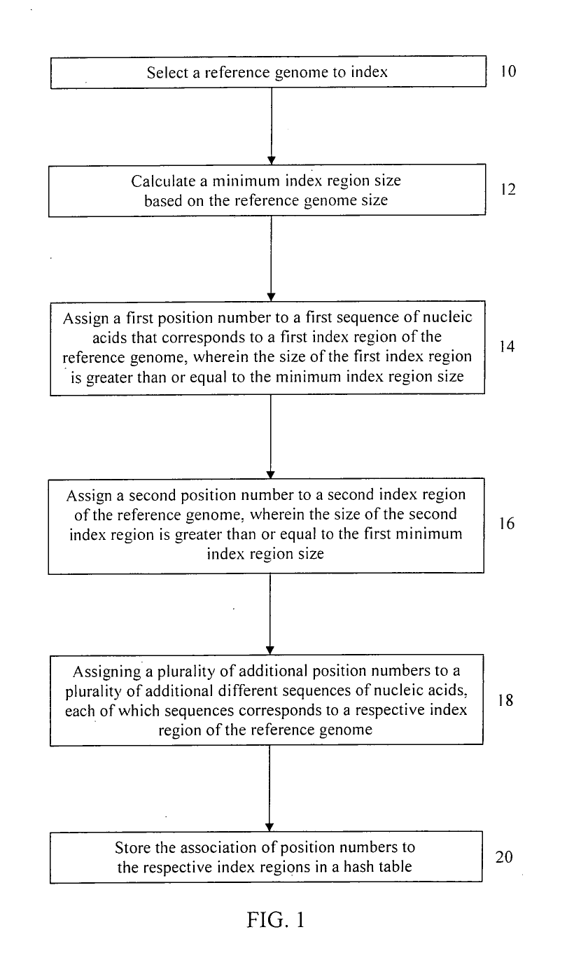

According to various embodiments of the present teachings, a method for indexing a reference genome is provided. The method is exemplified by the flow chart shown in FIG. 1. The method can comprise a step 10 of selecting a reference genome to index, a step 12 of calculating a first minimum index region size based on the reference genome size, a step 14 of assigning a first position number to a first sequence of nucleic acids that corresponds to a first index region of the reference genome, a step 16 of assigning a second position number to a second sequence of nucleic acids that corresponds to a second index region of the reference genome, and a step 20 of storing the association of the first and second position numbers to index regions in a hash table. In some embodiments, the method can comprise a step 18 of assigning a plurality of additional position numbers to a plurality of additional different sequences of nucleic acids, each of which sequences corresponds to a respective index region of the reference genome. The size of the first index region is greater than or equal to the first minimum index region size. The second index region can overlap with at least one base included in the first index region.

In some embodiments, the method can comprise calculating a second minimum index region size based on the reference genome size, wherein the second minimum index region size is shorter than the first minimum index region size. In so doing, a process or k-mer patching can be provided, as described herein. A third position number can be assigned to a third index region of the reference genome, wherein the size of the third index region is greater than or equal to the second minimum index region size. A fourth position number can be assigned to a fourth index region of the reference genome, wherein the fourth index region overlaps with at least one base included in at least one of the first, second, and third index regions. The association of the third and fourth position numbers can then also be stored to index regions in the hash table.

According to various embodiments, the reference genome has a total number of bases and calculating a minimum index region size can comprise taking a log of the total number of bases in the reference genome. For example, the calculating can comprise taking the third log, the fourth log, or the fifth log, of the total number of bases in the reference genome. In some embodiments the calculating comprises taking the fourth log of the total number of bases in the reference genome.

In some embodiments, the second index region can overlap with two or more bases included in the first index region, for example, it can overlap with a plurality of bases in the first index region.

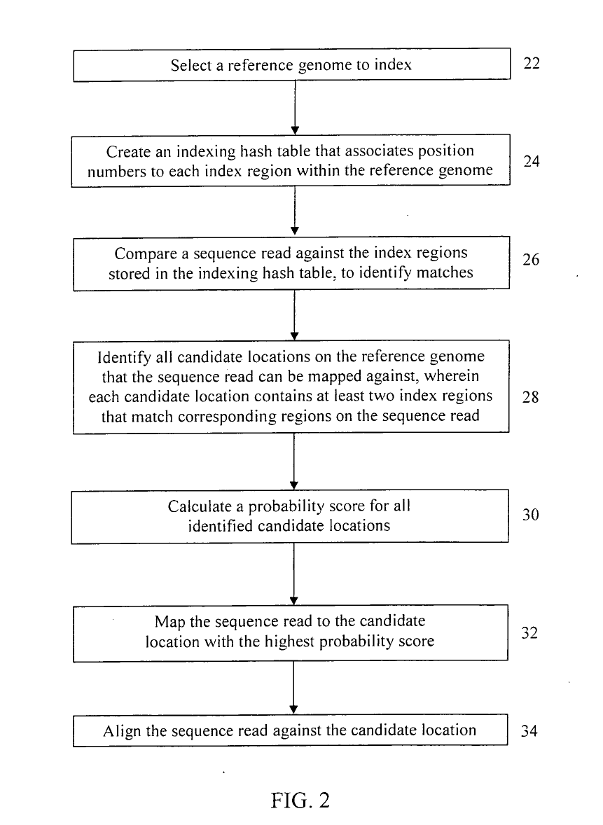

The present teachings also provide a method for mapping a sequence read to a reference genome. According to various embodiments, the method can comprise the steps shown in the flow chart of FIG. 2, which can include a step 22 of selecting a reference genome to index, a step 24 of creating an indexing hash table that associates position numbers to sequences of nucleic acids in each of a plurality of index regions within the reference genome, and a step 26 of comparing a first sequence read against the index regions stored in the indexing hash table, to identify matches. The method can further comprise a step 28 of identifying all candidate locations on the reference genome that the first sequence read can be mapped against. Each candidate location can contain at least two index regions that match corresponding regions on the first sequence read. The method can further comprise a step 30 of calculating a probability score for each of the identified candidate locations, a step 32 of mapping the first sequence read to the candidate location with the highest probability score, and a step 34 of aligning the first sequence read against the candidate location. In some embodiments, the method can comprise creating an indexing hash table that: (1) associates a first set of position numbers to a first set of sequences of nucleic acids corresponding to index regions within the reference genome; and (2) associates a second set of position numbers to a second set of sequences of nucleic acids corresponding to index regions within the reference genome, wherein each index region of the second set of index regions has a length that is shorter than each index region of the first set of index regions.

In some embodiments, the method can further comprise k-mer patching missing locations on the reference genome. The patching can comprise comparing a second sequence read, shorter than the first sequence read, against the second set of index regions stored in the indexing hash table, to identify matches. Then, all candidate locations on the reference genome that the second sequence read can be mapped against, are identified. Each candidate location can contain at least two index regions that match corresponding regions on the second sequence read. A probability score can then be calculated for each of the identified candidate locations that the second sequence read can be mapped against. Next, the second sequence read can be mapped to the candidate location with the highest probability score, and the second sequence read can be aligned against the candidate location.

According to various embodiments, the method can further comprise identifying a second sequence read comprising a plurality of k-mer reads of ten or less, eight or less, six or less, or five or less nucleic acid bases. The second sequence read can be compared to a wildcard indexing table and the second sequence read can be located on the reference genome based on the comparing. The wildcard indexing table comprises a plurality of wildcard sequences and each of the wildcard sequences can comprise a sequence of from one to eight nucleic acid bases.

In yet other embodiments of the present teachings, a method is provided that comprises identifying an error in a first sequence read, and fixing the error in the first sequence read. Identifying the error can comprise, for example, computing an expected coverage at a location on the reference genome and comparing the expected coverage to an average coverage. Other error correction steps can be used according to the present teachings, and can comprise, for example, identifying a likely error in a first sequence read, identifying an error in the first sequence read that is the same or about the same as the identified likely error, and fixing the error in the first sequence read. The likely error in the first sequence read can be determined, for example, using Poisson distribution.

According to various embodiments of the present teachings, a system for indexing a reference genome is provided, for example, a system configured to carry out an indexing method as described herein. In some embodiments, the system can comprise a memory for storing computer readable code, and a processor coupled to the memory. The processor can be configured to select a reference genome to index, calculate a minimum index region size based on the reference genome size, assign first and second position numbers to first and second sequences of nucleic acids corresponding to index regions of the reference genome, and store the association of position numbers to index regions in a hash table. The size of the first index region can be greater than or equal to the minimum index region size. The second index region can overlaps with at least one base included in the first index region. The processor can comprise a hardware module.

In some system embodiments, the processor can further be configured to calculate a second minimum index region size based on the reference genome size, wherein the second minimum index region size is shorter than the first minimum index region size. The processor can assign a third position number to a third sequence of nucleic acids corresponding to a third index region of the reference genome, wherein the size of the third index region is greater than or equal to the second minimum index region size. The processor can also assign a fourth position number to a fourth sequence of nucleic acids corresponding to a fourth index region of the reference genome, wherein the fourth index region overlaps with at least one base included in at least one of the first, second, and third index regions. The processor can also store the association of the third and fourth position numbers to index regions in the hash table. As described with reference to the present methods, the processor can calculate a minimum index region size by taking a log of the total number of bases in the reference genome, for example, by taking the fourth log of the total number of bases in the reference genome.

According to yet other embodiments of the present teachings, a system for mapping a sequence read to a reference genome is provided. The system can comprise a memory for storing computer readable code, and a processor coupled to the memory. The processor can be configured to select a reference genome to index, create an indexing hash table that associates position numbers to each index region within the reference genome, and compare a sequence read against the index regions stored on the indexing hash table, to identify matches. The processor can also identify all candidate locations on the reference genome that the sequence read can be mapped against. Each candidate location can contain at least two index regions that match corresponding regions on the sequence read. In some embodiments, a probability score for each of the identified candidate locations can be calculated by the processor, and the sequence read can be mapped to the candidate location exhibiting the highest probability score. Subsequently, the sequence read can be aligned against the candidate location. According to some embodiments, the processor can comprise a hardware module, a firmware module, a software module, or a combination thereof. The processor can furthermore be configured to patch missing locations on the reference genome by calculating a second minimum index region size based on the reference genome size, comparing a second sequence read against index regions of the second minimum index region size stored in the indexing hash table, to identify matches, and identifying all candidate locations on the reference genome that the second sequence read can be mapped against. The second minimum index region size can be shorter than the first minimum index region size, and each candidate location can contain at least two index regions that match corresponding regions on the second sequence read. The processor can also calculate a probability score for each of the identified candidate locations that the second sequence read can be mapped against, and map the second sequence read to the candidate location having the highest probability score. Subsequently, the second sequence read can be aligned against the candidate location.

In some embodiments, the processor can comprise a signal input and the system can further comprise a gene sequencer having a signal output, wherein the signal output of the gene sequencer is operatively connected to the signal input of the processor, for example, such that the first and second reads, and other reads, can be generated by the gene sequencer.

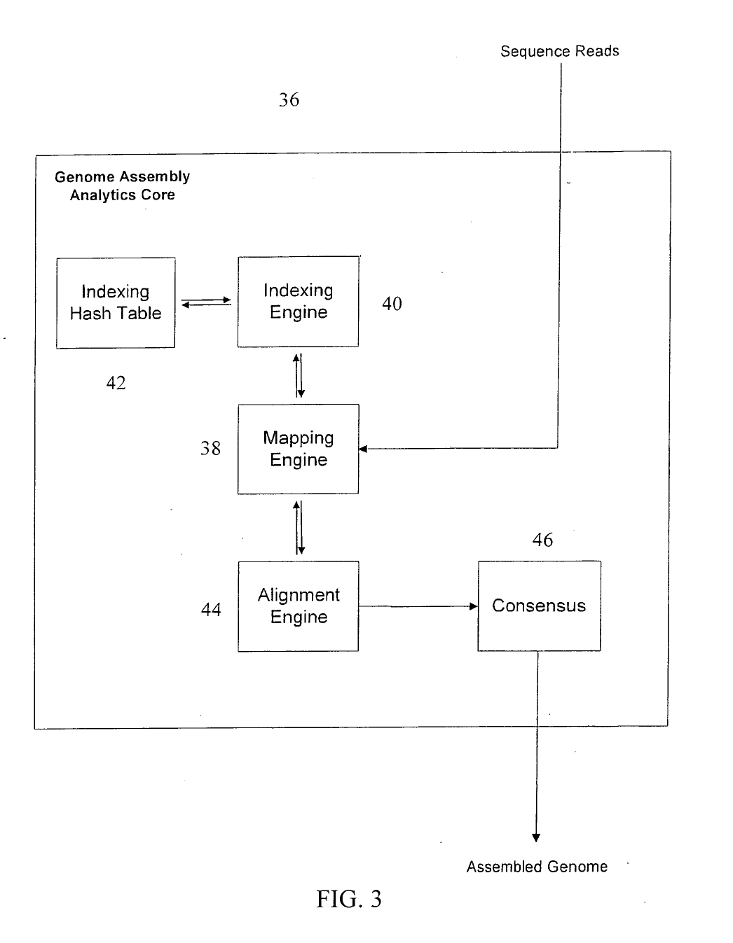

FIG. 3 is a schematic diagram of a system according to various embodiments of the present teachings. As shown in FIG. 3, the system can comprise a genome assembly analytics core 36 into sequence reads can be input. The sequence reads can be input to a mapping engine 38 that is operatively connected to an indexing engine 40. Indexing engine 40 can be operatively connected to an indexing hash table 42. After indexing, information can be sent from indexing engine 40 back to mapping engine 38 and through to an alignment engine 44 that is operatively connected to mapping engine 38. Alignment engine 44 can send alignment information to a consensus unit 46 where a consensus sequence can be constructed and from which an assembled genome can be output.

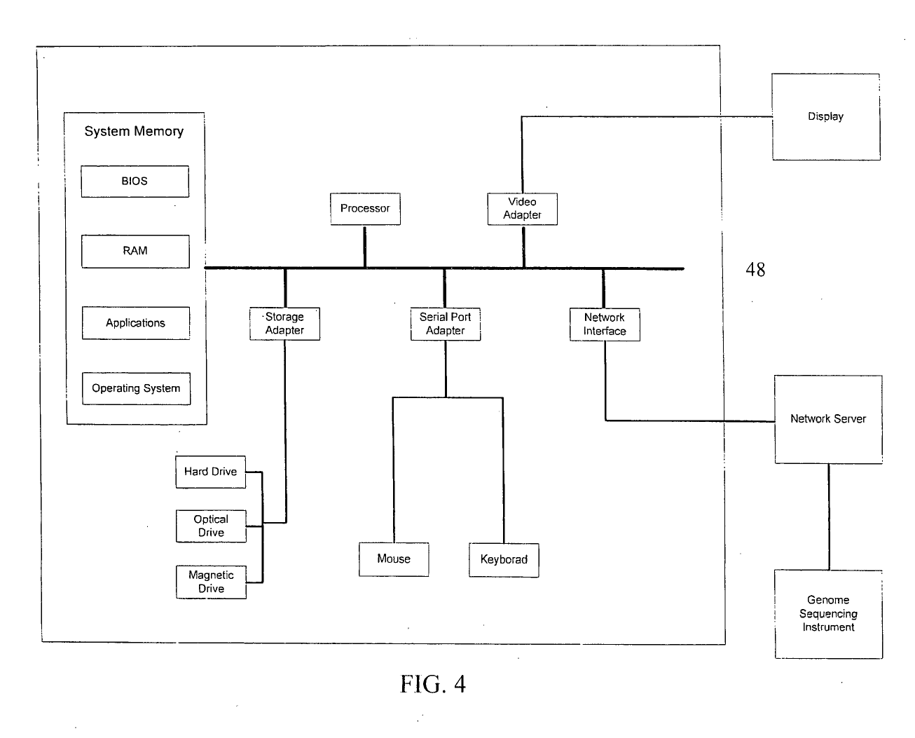

FIG. 4 is a schematic diagram of a system 48 for mapping sequence reads generated from a genome sequencing instrument, to a reference genome, according to various embodiments of the present teachings. As shown in FIG. 4, system 48 can index and map as described herein and send information thus obtained to a display device or printer whereat the information can be displayed and/or printed. In addition to a genome sequencing instrument and a display being operatively connected to system 48, a network server can also be operatively connected to the genome sequencing instrument and system 48.

According to various embodiments, experimental estimates of SL-parameters can be used to tailor strategies presented herein for particular equipment or situations. In some embodiments, a template (index) based overlap detection system is provided.

Due to the computational challenge of the overlap detection, and the probably small average k-mer size of reads that are uninterrupted by wildcards, for example, assuming a worst case average k-mer size is expected to be around 5, The present teachings provide an approach that makes use of existing already sequenced genomes as an overlap detection strategy. This can involve any genome, such as the human genome, that has already been sequenced and assembled, or a genome wherein the evolutionary distance between the species of the genome being assembled and that of an already existing assembly is fairly small.

In an exemplary situation, when given two reads, r1 and r2, with k-mers k1 and k2, chances are very low that they share a k-mer if the frequency of wildcards is high. In order to still be able to link two overlapping reads, an index of all k-mers is created on a reference or template sequence instead. This index only has to be created once, and allows potentially overlapping reads to be found. When potentially overlapping reads are identified, they can then be aligned using a full dynamic programming algorithm.

### Indexing an Already Existing Genome

An efficient index such as a persistent suffix tree or suffix array can be created by identifying one or more sequences of mers to be indexed. For example, k-mers can be selected to be indexed, where k is a selected number. In exemplary embodiments, k can be 5, 10, 15, 20, 25, 30, 35, or more, depending on the length of the reference genome to be indexed. This index would only have to be created one time for each existing genome and can then be re-used for any number of SL assemblies on species of that genome.

### Indexing SNP and Other Variable Regions

An advantage of this indexing strategy is that all known SNP's and other variable sequences can be added to the index. That way, overlap detection can be improved. By adding any new variation to the index, the index can be continuously improved. This index can be used in genome assembly of a species or homolog of the indexed genome, as described below.

### Overlap Detection Using the Index

In an example, the frequency of a wildcard mer can be designated w, that is, there is a w chance that a base will be called or missed. For example, if w=0.2, an average k-mer size would be 5. The probability of observing a k-mer of length k in a read of size m would be: (1−w)̂k*m/k. The probability of observing k-mers that are longer than k is then the sum from i=k to m (1−w)̂i*m/i. Thus, the expected number of k-mers of a certain size based on the read length and w can be computed. Examples for the number of expected k-mers for w 0.2 and m=5000, for example, the expected number of k-mers larger than 18, is about 15. As long as there is at least one k-mer of a reasonable size, it can be used to approximately map a read having that k-mer to the existing genome. The more useable k-mers in a read, the more precisely and confidently the read can be mapped to the genome, without further analysis.

### Example Implementation of Template Indexing

Below is an example how to use Oracle to store an index of all k-mers, using a bit-representation, for example, using an integer to represent each index entry. By so doing, an entire k-mer, or concatenation of k-mers and interposed gaps of indeterminate size, can be mapped to one integer, making it very fast, and so the index itself and any queries on it can comprise integer comparisons. In some embodiments, partitioning of the index speeds up the lookup considerably.

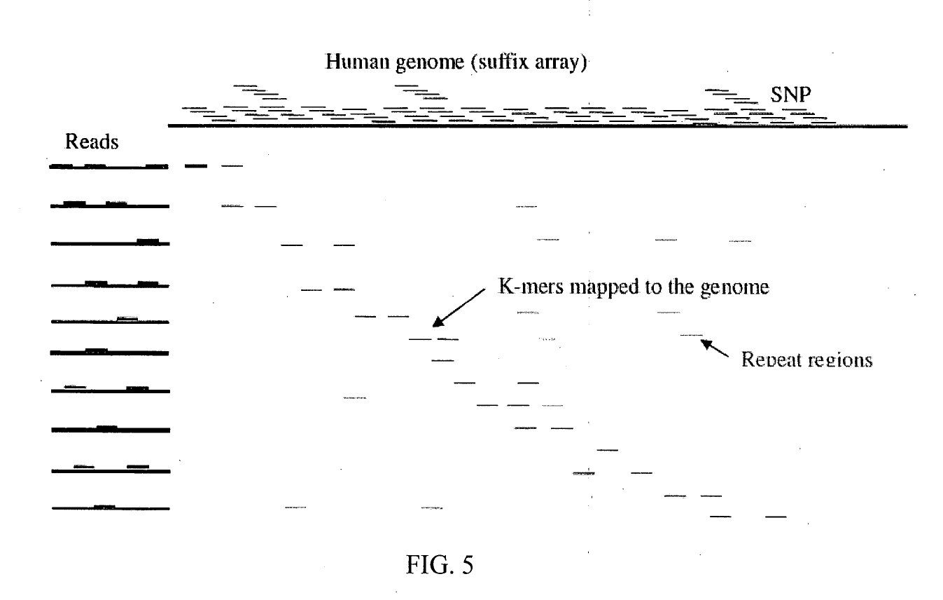

FIG. 5 shows a human genome suffix array that can be used according to various embodiments of the present teachings. Given such a suffix array, overlap detection can be computed as follows. For each of the r reads, the present teachings can involve:
a. Retrieving the longest k-mers from the read, wich can be done in O(m) where m is the average length of a read.
b. For each of the k-mers, finding location(s) in the reference sequence using the suffix tree or index, which takes O(k) time for a suffix tree, and O(log(n)) for a suffix array.
c. Finding the top v locations on the reference sequence with the best hits based on the number of hits and the expected distance of the target genome with the assembled genome, as discussed below, that is, based on comparing k-mer alignments from a read and identifying top candidate locations for the read.
d. For each of the best identified locations, computing a full optimal alignment using dynamic programming and determine a score, for example, a probability score, that this is a real match.

According to various embodiments, k-mer stitching, as described below, can be used to reduce an amount of pair-wise alignment done for each read. The entire operation so far can be linear in n, or n*log(n) if a suffix array is used. The stitching will place each read on one or several locations on the genome. A full alignment of the read can then be completed against those locations to identify the most likely matches.

In some embodiments, there can be reads that cannot be located because the variance at a location is too high or because the read quality is too low. For those remaining reads, the following steps can be used:
a. Compute a consensus sequence of the placed reads
b. For any region that shows high variation to the template assembly, add the changed k-mers to the suffix tree
c. For any read that was previously not placeable onto the target genome, repeat step a. using the extended suffix tree.

For each new assembly, that is, for each new genome, the suffix tree index can thus be extended and will incorporate more and more regions that have high variation, which will speed up and simplify any subsequent assembly in the future. Also, this will help identify regions that vary between individual people. In some embodiments, existing SNP data can be loaded into the database to cover all known variations.

Performance Estimates with an Oracle Implementation

The one-time creation of a suffix array for the entire human chromosome 1 for k=19 can be created in about 30 minutes on a personal computer—including loading the suffix array into an Oracle database.

The mapping of 1000 reads to the e. coli genome can be completed in 16 seconds or less. For the human genome, which is roughly 1000 times larger, mapping can be done in four to five hours, or less. If a suffix array is used on the human genome, the mapping can be completed in about 15 hours or less.

### Database Approach Advantages:

Alternative approaches can comprise storing indices in a file and implementing caching algorithms or using a database approach. In some embodiments, a database approach is used that exhibits great speed of development and scalability. In some embodiments, index and table partitioning of Oracle (and caching) can be used. A database approach can be used that can be scaled up to multiple genomes. In some embodiments, Oracle can be run on multiple machines and clusters easily.

### Using Indexes as Described—Acceptable Variations Between Genomes

For SL reads, provisions can be made to accommodate for information gaps in reads. When taking SL reads, failures to completely sense the bases of a given read can be caused by blinking. Based on teachings described at: http://en.wikipedia.org/wiki/Humanevolutionarygenetics#Sequencedivergencebetweenhuman sandapes, The average distance between humans and apes is about 1-2%. The highest variability is found in Aluelements, where the distance is on average around 2%.

In some embodiments, a suffix tree method is used that employs exact matches on k-mers. Algorithms can also be used that allow for errors. In an example, t is designated as the number of k-mers in a read used for searching, and d is the distance of the genomes in percent at the target location. Even though, on average, the distance may be low, it is possible that there is a higher variation at some locations.

The chance that a k-mer has no mismatch is (1−d)̂k. So for a k-mer of size 24 and an evolutionary distance of 2% one would expect approximately 61% of the k-mers to match to the target location. If the distance is 3%, then approx. 48% of the k-mers would match exactly, and if the distance is 5% then 29% would match. For these example, the evolutionary distance also includes the expected error rate of the base calling.

Table 1 shows an estimation of how large the template genome can vary from a genome in question, and what the expected number of hits are for k-mers when using the suffix tree index.

TABLE 1

| | | | # of k-mers that |
|---|---|---|---|
| | Evolutionary | % of k-mers | would be expected |
| K-mer | distance to | that have exact | to match per |
| size | reference genome | matches on average | read for t = 50 |
| 24 | 2% | 61% | 30 |
| 24 | 3% | 46% | 24 |
| 24 | 5% | 29% | 15 |
| 24 | 10% | 8% | 4 |
| 12 | 2% | 78% | 39 |
| 12 | 3% | 69% | 35 |
| 12 | 5% | 54% | 27 |
| 12 | 10% | 28% | 14 |

Referring to Table 1, if the average error for a base call is 1%, and the distance between the genome is 2%, then 3% can be used in the estimation. If it turns out that the error rate of the base calling is very high (>5%), then the distance to the template genome is high. A method that allows errors can then be used. In some embodiments, for example, one mismatch can be allowed by searching all variations with one mismatch of a k-mer. This notion can be generalized to Indexing with Mismatches, as described below.

Additional ways of solving the fast overlap detection problem can comprise attaching 2 qdots, or more, to a polymerase. This would reduce the rate of a wildcard and thus make k 3 times larger because there would only be a wildcard when both qdots happen to be off. Thus, the probability would be ŵ2 for a wildcard when w is the probability that the qdot is off.

Indexing with Mismatches

In some embodiments, indexing with contcatenations of k-mers with wildcards can be useful, for example, if the k-mers are too short to be independently useful in initially aligning a read to the genome. For example, assume the distribution of the k-mers is such that the method does not get longer k-mers on each read, but that the reads are indeed mostly 5-mers and not longer. An index that contains “wildcards” can then be created so that the method can still get at least an index on 15-mers in total, even though these 15-mers are spread among a larger section. For example, if gaps exist that are one to seven bases in length, then there could be a total of about 29 bases, of which 15 are comprised of 5-mers.

In an example, take this read with 3 blocks of 5-mers:

ATGCT*GGCTA*ATGCT
“A” “B” “C”

The first 5-mer block can be designated A, the second one can be designated B, and the third one can be designated C. An index can thus be created on the reference genome, such as the human genome, with all possibilities for A*B*C.

As each wildcard may be from 0 to n bases in reality, a maximum number of bases to be considered can be selected, for example, eight, in order to limit the size of the index. If g is the maximum number of bases that are considered for any wildcard, then the index size will be n (the length of the genome)*ĝ2*k (a k-mer size of 15). In such an example, the total index size would be 960 times the size of the genome, so that would be roughly 3 terabytes for the human genome. While this is a large index, it can be computed just once and can be reused for any number of assemblies. Partitioning the index and table into many partitions (1000 or more) can be useful in order to be able to very quickly find a match.

### Computing the Index

According to various embodiments, an algorithm to compute an index can be as follows:

```
- For each position i in the genome (from 0 to n-k)
    - For each gap size 1 (from 0 to g=8)
        - For each gap size 2 (from 0 to g=8)
            - Extract the k-mer and represent it as A*B*C
            (a sequence with 2 wildcards)
            - Compute the integer representation (bit->integer) (or hash)
            - Store it in the index table (with the chromosome location)
            - End
    - End
- end
```

### Using the Index

To locate a read on the reference genome, an exemplary method can include:
For a given read r, find a stretch of sequence that has the pattern A*B*C (5 bases, wildcard, 5 bases, wildcard, 5 bases)
Use the index to locate it on the genome
Proceed as in the other indexing strategy above (for example, using non-wildcard indexing)

### Combining Techniques

Depending on the actual k-mer distribution, a combination of methods can be used. If a lot of 8-mers or 9-mers are generated, but not longer k-mers, an index can be constructed, for example, comprising k-mers of A*B, which yield 16-mers or more. In some embodiments, multiple indices can be created and whichever is best for a particular read can be used. Thus, for indexing a given genome, a genome-by-genome selection can be made for an appropriate index to use. For reads that have long k-mers, a regular index can be used. For shorter k-mers, an A*B index can be used, and for very poor reads, an A*B*C index can be used. That way, good reads can be processed a lot quicker than bad reads, but reads can still be used even if they have very poor quality.

Updating the Genome Index with New Variations

Some of the reads will most likely have mutations compared to the reference genome. For regions where the constructed consensus sequence has a very high quality score with a high chance that the call was done correctly, the index can be updated by including all k-mers that include the mutation, for example, that include an inserted or deleted base.

### Advantages

Various advantages can be achieved according to the present teachings. For example, long reads contain longer stretches of uninterrupted sequences (k-mers) because k-mer distribution is a standard geometric distribution. A one-time index of all k-mers on the human genome (a suffix array) can be created. The longest k-mers read can be mapped to read on the human genome by using an index ->linear algorithm. Also, after mapping is done, a consensus sequence can be computed using traditional approaches. Further indexing, or localized searching, can also be performed.

### Mapping Reads to a Reference Genome

According to various embodiments of the present teachings, once all the SL-reads have been placed onto the reference genome using the template genome index, one or more of the following steps can then be performed. The reads can be placed onto the most likely place in the genome by scoring the k-mer matches. The reads can be aligned to the genome, for example, by using fast alignment techniques that avoid a full pairwise alignment. A consensus sequence can be constructed, for example, including error correction, using the information from the reads and the reference genome. The genome template index can be updated with new variations. A de novo assembly can be performed in highly variable regions or for reads that were not placeable.

Aligning the Reads onto the Genome

In some embodiments, the present methods can comprise determining the most likely locations of the reads in the genome, for example, in cases where a read is placed at multiple locations. The overall quality of the placement can also be determined. Some k-mers that were mapped to the genome may be due to chance, errors, repeat regions, combinations thereof, and the like.

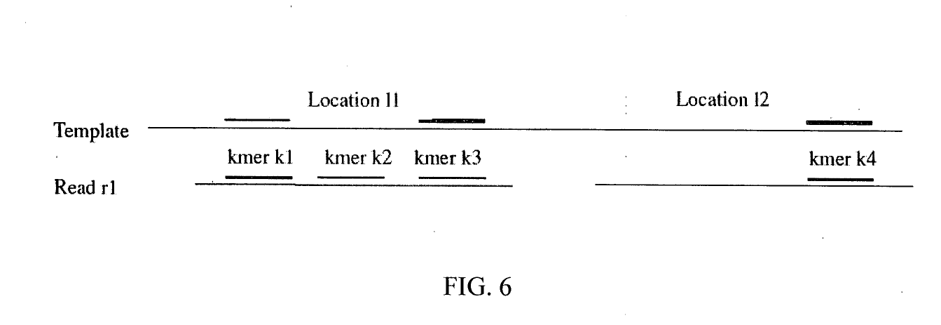

An exemplary embodiment is shown with reference to FIG. 6. Given a read r1 with 5000 bases with k-mers k1-k4, two of which were mapped to the genome region l1, and k-mer k4 was mapped to the region l2 using an index. FIG. 6 can be referred to in consideration of the next four sections.

### Scoring the Match to a Location

For each region that the sequence read mapped to, one or more k-mers may have matched, and one or more k-mers may not have been found. Both situations can be analyzed to calculate the probability that each location is a true match. Let K be the set of k-mers of a read used to locate the read on the genome. For each location, let M be the set of k-mers that matched this location, and let N be the set of k-mers that did not match this location (so K={N,M}).

### K-Mer of a Read Matched

For each k-mer in M that matched, there is a certain probability that this match was coincidence. This depends on the size of the k-mer, and on the number of times a particular k-mer appears in the genome. If the k-mers were all evenly distributed, then the probability that a k-mer matches randomly is: P(random)=|genome|/4̂|k-mer|. If statistics are collected on how often a k-mer appears in the genome, then p(random) (i.e., not a true match) is: P(random)=|genome|/# occurrences genome.

### K-mer of a Read Did not Match

If a k-mer did not match even though the location is correct, then this could be due to: Variation in the genome (SNP), sequencing errors in the reference genome, a mutation, or a read error.

Let d be the average “distance” between the read and the reference genome (including: read error, mutations, variations, and the like), such as 1%. The probability that a k-mer did not match due to this distance is: P(no match)=(1−d)̂|k-mer|

The longer the k-mer is, the larger the probability of a mismatch. Moreover, the larger the distance d is, the higher the probability of a mismatch.

### Score of a Location

For each location L that may match to a particular read, the score of the match of k-mer sets M (matches) and N(mismatches) is then the sum of the log of the individual probabilities:

S(L)=log(P(this is real)/P(this is random))

P(this is real)=|N|+|M|

P(this is random)=(|N|*|genome|/4̂|k-mer|+|M|*(1−d)̂|k-mer|)

Score S(L)=|N|+|M|/(|N|*|genome|/4̂|k-mer|+|M|*(1−d)̂|k-mer|)

### Pairwise Alignment Challenge

Pairwise alignment can create problems with dynamic programming, on the order of O(m̂2) time (where m is the length of the read). Because read length can be high according to various embodiments, computing alignment for all reads, even just once, may take an undesirably long time. It is beneficial to use as much information as possible that is already gathered from the indexing step. By fixing the alignment at the places where there are already k-mer matches, the alignment problem can be divided into two subproblems. Further optimization of alignment processing can be accomplished by using more known k-mer alignments to fix a read in more positions to the genome.

Let t be the number of k-mers per read (including k-mers of the form A*B or A*B*C) that were mapped to the genome (per genome location. That is, t is for a location-by-location analysis, where multiple possible locations for the particular read remain). Let 1 be the number of genome locations that were found for each read. Then, the time to align one read to the genome is: O((m/(t+1)̂2*1). As can be seen, the more k-mers that are used, the shorter the time is to compute the alignments.

### Dynamic Programming Example of Reduced Complexity Using Indexes

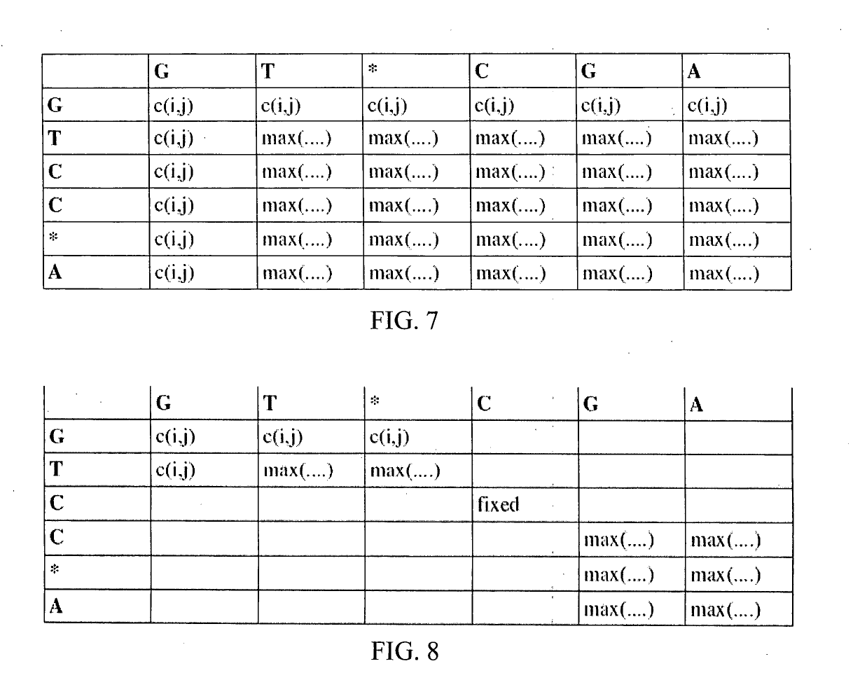

For the dynamic programming of two reads of length m, the time to compute the optimal aligment is on the order of O(m̂2), which equals the time it takes to compute the entire matrix shown in FIG. 7. However, if even just one location in the entire aligment can be fixed, for example, a k-mer or even just one base, then the problem is only one quarter of the size as before. All that would need to be computed would be the values in the non-empty cells, as demonstrated by the matrix shown in FIG. 8.

So for t k-mers that are used per read, the problem is (t+1)̂2 smaller. For t=1 the problem is ¼ of the size, for t=2 the problem is only 1/9 of the size, and for t=3 the problem is 1/16 of the size as the full problem.

In some embodiments, k-mer patching, as described below, is a way to reduce the size of the dynamic programming problem by fixing more k-mers within a read.

### K-Mer Patching

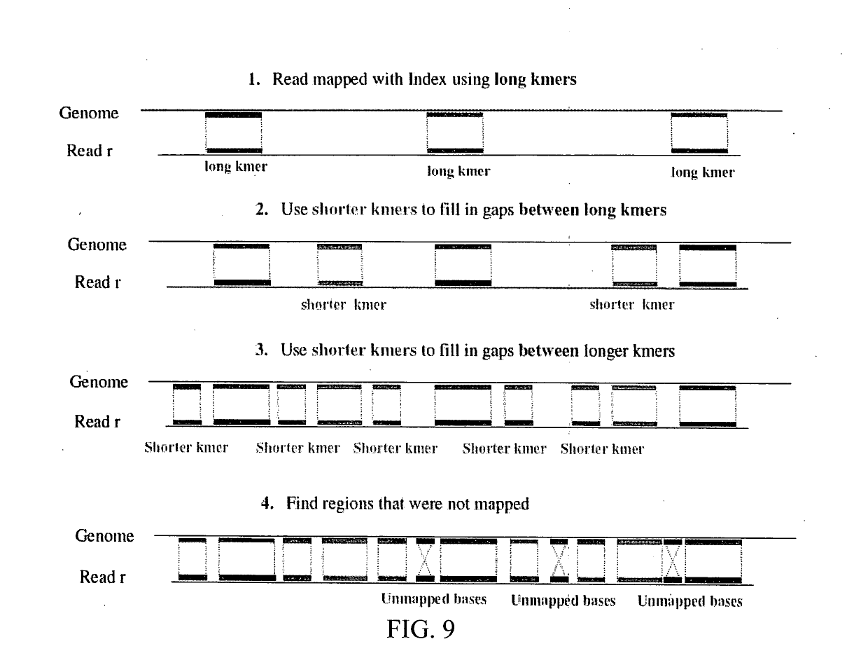

By using all possible k-mers, the computational challenge that pairwise alignments poses can be avoided. In some embodiments, first, the longest k-mers are used to map the reads with the index as described above. Given the approximate location of the read, shorter and shorter k-mers can then be used to map the regions between the longer k-mers. This works because instead of searching an entire genome, the method now looks at very small areas, smaller than the length of a read. With each new mapping, the size of unmapped areas becomes smaller and smaller, and thus smaller k-mers can also be used each time without running into the risk of mapping them to the wrong locations, since the target regions get shorter and shorter. A four-step process flow diagram demonstrating k-mer patching is shown in FIG. 9.

At the end, it is expected that some percentage of the reads cannot be mapped, despite adequate coverage, for example, up to about two percent. The inability to map can be due to mutations, errors, variations, and the like. These regions are then the only regions left that have to be aligned, and these can be very short, for example, a few bases only.

### Mapping Unmapped Bases

As shown in FIG. 9, there are regions that could not be mapped with the k-mers, because of mutations, variations, errors, and the like. These are the only regions left that have to be aligned with a pairwise alignment approach. These regions are very small, on the order of 5-10 bases at most, and they can comprise only about 1-2% of the genome depending on the quality of the reference genome and the evolutionary distance between it and the reads.

### Data Structures and Technical Details

In order to efficiently compute the alignments, the time it takes to fetch part of the genome sequence from a large file can be contemplated. In some embodiments, chunks of the genome can be fetched at a time, such as 30 kB. The chunck can be large enough to contain at least the largest read, but short enough to avoid memory allocation costs and the like considerations. Let the data structure that contains a piece of the genome be called Chunk (extending the datamodel.Sequence object, which uses a byte representation of the sequence string). A chunk contains (besides the sequence) the start_location and chromosome number of the genome. To read chunks from either a fasta file, from a database, or from anything else, the retrieval of the sequence can be coded in a separate module called GenomeFetcher which returns one Chunk at a time. This GenomeFetcher decouples the retrieval from the data storage used so that later one can easily move the sequence into a database or keep it in a flat file, without having to change the algorithms. A component ReadFetcher retrieves the read with a particular id, whether from a database, from a fasta file, or from elsewhere. The output from the indexing step is a list of Match objects stored in the database. Each Match contains the read_id (read number), location in genome, chromosome number, and the start position of the k-mer in the read. The matches are sorted by location and grouped by read. Each read has a list of Match objects.

The algorithm then to compute the alignments for all reads for all locations can be as follows:
Sort the matches by location
Starting at genome position 0, retrieve a Chunk of DNA
Look at all matches in this region and fetch the corresponding reads
Align all reads given in the match objects to this chunk of DNA
Discard bad matches
Update the score of the good matches in the database.

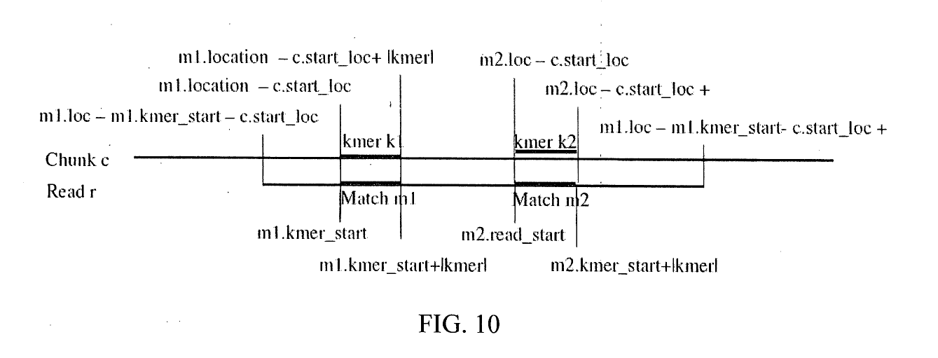

For a particular Chunk and a particular read, the situation looks like the datastructure shown in FIG. 10.

The data structures have methods to retrieve and compute the correct start/end positions of the DNA-pieces from the Chunk and from the read to compute the alignments.

Chunk(Match).getReadStart( ) returns the position in the Chunk of the estimated read position. To compute the alignment, a few extra bases can be included in case there are gaps in the alignment.

Chunk(Read, Match).getReadEnd( ) returns that last base of the chunk that will probably align with the read. Again, a few extra bases can be added in case there are gaps.

Chunk(Match).getKmrStart( ) returns the position of the first base where the k-mer matched.

Match.getK-merStart( ) returns the position of the first base where the k-mer starts in the read.

The implementation of the ReadFetcher can use a dynamic index to a fasta file. That is, as reads are read, the index is built up, and subsequence access to the file becomes faster and faster.

### Evaluating the Accuracy of the Mapping

For each alignment to the genome, the score (probability) of the alignment is obtained. The score can be used to determine if the alignment is real or not, or if the k-mers matched due to coincidence or repeat regions. A cut-off value or threshold can be used to filter out bad matches, while not throwing away too many good matches. In some embodiments, each read only maps to one location in the genome, however, it is likely that a subset of the reads will still map to multiple regions due to repeats or mismatches.

### Constructing the Consensus Sequence

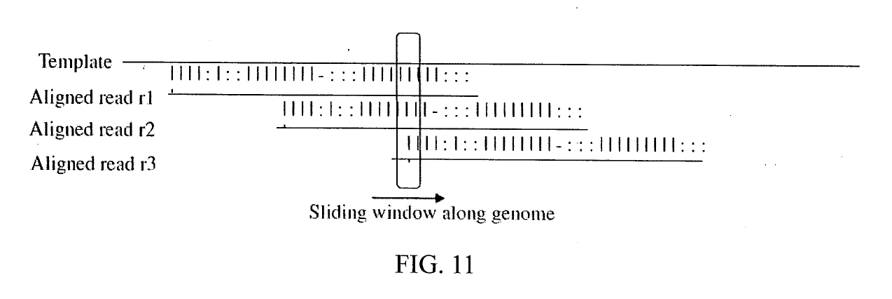

According to various embodiments, the method can comprise constructing a consensus sequence. The input for this stage will be the mapped and aligned reads to the genome. For each read r, there is a set of probable locations with scores. In order to construct the best consensus sequence, the reads that have been mapped to one location only are first determined, where the score is also adequate. The reads with just one location can be sorted by the location, which can be used to create a situation as shown in FIG. 11. At this point, any reads that were mapped to highly variable locations can be excluded, and a de-novo assembly can be performed for those reads. Also, reads that were placed onto multiple locations with high quality scores can be dealt with separately. As shown in FIG. 11, starting from position 1, the algorithm can be slid over the entire genome that has mapped reads, and for each position, the consensus sequence can be determined together with the quality score. This procedure should be linear in the size of the genome.

### Overlap Detection

The Overlap Detection problem can be decomposed into several sub-problems including:
indexing the reads in order to quickly find potentially matching reads. The strategy used can depend on k,—as described above
finding the optimal alignment between two reads
scoring the alignment of two reads and determining the probability that this alignment is correct vs. incorrect

### Develop a Scoring Schema for Comparison of Two Reads

The parameters of the scoring schema in traditional sequence comparison vary depending on the evolutionary distance between sequences, for example, PAM60 vs. PAM250 matrices. While reads refer to the same genome, the parameters m, r, k, and f effectively mimic the sequence divergence. As a result, the optimal scoring parameters will depend on r, k, and f. Let r1 and r2 be two reads which are aligned in a certain manner resulting in the strings a1 and a2, and let 1 be the length of the entire alignment. Let S(a1, a2) be the score of such an alignment. The following describes aspects of devising a scoring function that takes the individual “personalities” of each Qdot into account. In this example, a sample alignment is performed on two reads

al: GAT*TTCT***ATAG*TTGAGT**CAT*
a2: TT*AGT_ACGT*TAGT**GTCGT

To determine the probability that this alignment is correct compared to the random event, a log odds ratio can be used to express this. For example,

S(a1,a2)=10 log(P(match)/P(random)).

The score S(a1,a2) of the entire alignment is the sum of the scores of each position in the alignment:

S(a1,a2)=sum from {i=0} to {1} S(a1_{—}{i},a2_{—}{i})

For the score of each individual position, 4 cases need to be considered:
A base matches another base (such as a T matching a T).
One or more bases matching a wild card region of a certain length (such as a GT matching a *)
A wildcard matching a wildcard (*vs*) of a certain length

A base not matching another base (such as a A matching a G)

For each case, the probability that it is correct versus the probability that it is a random match can be determined. Since we are not looking at evolutionary distances, the probabilities are entirely determined by the biochemical parameters such as f(error rate), b(average number of bases inserted by the polymerase) and other parameters. Looking at each of the 4 cases, the probabilities for each case can be determined.

### 1. Base Matches Base

The score of a base matching a base

S(a1_{—}{i},a2_{—}{i})=P(base matches)/P(random event).

If the reads had no error (f=0) then P(base matches) would be 1. Since it is assumed that the determination of a base (base call) has errors, the probability that this is correct is the product of 1—the probability that this is wrong for both bases. Let f(a_i) be the function that determines the probability that the base call at position i in the alignment string a is wrong. Then the probability that the 2 bases are matched correctly is: The probability that this is a random match is determined by the frequency of the base in the genome. Unless there is a special case such as a specific region in the genome, the probability t(b) for each base occurring is ¼. So, the parameter t(b) can be used for this in case there is a special case. Hence the probability that the two bases are random matches is t ib. Hence the score S(a1_{i}, a2_{i}) for a base matching a base is:

S(a1_{—}{i},a2_{—}{i})=10 log((1−f(a1_{—}i))(1−f(a2_{—}i))/t(b)̂2)

### 2. One or More Bases Matching a Wildcard Region of a Certain Length

Let dt be the time that the qdot is off, for example, 10 seconds, and let G(dt, g) be the probability that during the time dt the polymerase inserted g gaps. In an example, the probability that the polymerase inserted g=4 bases during the time dt needs to be determined, as well as the probability that the polymerase inserted the bases GTAG (vs any other base). The score S₁ali, a2i₁ is then the probability G(dt, g) that g bases were inserted during the time dt, multiplied by the probability that the polymerase happened to insert the specific bases, vs the probability that this is a random match. The function G(dt, g) is determined by the parameter b, the average number of bases inserted by the polymerase per minute. This is a discrete distribution as the polymerase can only insert entire bases, but it can be approximated by a distribution function.

The probability that the polymerase inserted the specified bases is the product of the frequency of the inserted bases base t(b): prod from {i=0} to {g} t(b_i). The probability that this alignment is random is the probability of encountering those bases times the average frequency of the wildcard region g for that particular qdot prod from {i=0} to {g} t(b_i)*freq(wildcards).

### 3. A Base not Matching Another Base, Such as an A not Matching a G

In some embodiments, the probability that, despite a mismatch, bases do actually match, for example, where one base was a misread and the other was not, compared to a random event, is calculated. The probability for a match is then the probability that the first was a misread and the second was correct, or that both were misreads, or that the other was a misread and the first was correct: P(match)=f(a1_i)*(1−f(a2_i)+f(a1_i)*f(a2_i)+(1−f(a1_i)*f(a2_i)). The probability that this is a random event is the product of the frequencies of the bases at this position: t(a1_i)*t(a2_i). So the overall score in this case is: S(a1_i, a2_i)=10*log(f(a1_i)*(1−f(a2_i)+f(a1_i)*f(a2_i)+(1−f(a1_i)*f(a2_i))/(t(a1_i)*t(a2_i))). Considering all these enumerated cases, the score of a given alignment is the sum of the scores of each individual position in the alignment. The above presented scoring function takes the individual personalities of each qdot into account, and also takes the on/off time variance into account at each position of the read.

Given Two Reads, Finding their Optimal Alignment

In some embodiments, a scoring schema is given and dynamic programming is used. The scoring schema can be developed and parameters can be selected that adequately separate between statistically significant and insignificant alignments. In some embodiments, mismatches and indels in case of sequences with wildcards are avoided. Given the scoring function as described above, a dynamic programming is used to determine the optimal and/or most likely alignment between two reads. The alignment can maximize the probability that the two reads are indeed aligned. To do this, a matrix can be created of size |r1|×|r2| where r1 is shown on one axis and r2 is shown on the other axis. An optimal score at a position ij can be formulated in a recursive fashion.

### Evaluating the Score and Selecting a Cut-Off Value

In some embodiments, after an alignment is computed and a log odds ratio is generated, the score can provide the log of the ratio that the alignment is correct vs that the alignment is random. To determine if an alignment is truly good or bad, the number of reads r in the experiment can be used to determine a good cut-off value. In an example, a read r1 is aligned with a read r2 and a score of 10 was determined. That means that it is 10 times more likely that this is a real alignment vs. one random event. For even a greater predictability, the random event can be multiplied by the number of reads in order to find a cut-off value.

For 1 million reads, 10 log(r)=50, the score could be given a threshold of greater than 50 in order to be considered more likely to be a good alignment vs. a random event. For the assembly, in some embodiments, a threshold of 50, 60, 70, 80, or 90 can be used, for example, a threshold of from 70 to 90, or a threshold of 80. A threshold of 80 would mean that the probability that this is a good match is 1000 times greater than a random event.

While the present teachings have been described in terms of exemplary embodiments, it is to be understood that changes and modifications can be made without departing from the true scope of the present teachings.

What is claimed:

1. A method for indexing a reference genome, comprising:
selecting a reference genome to index;
calculating a first minimum index region size based on the reference genome size;
assigning a first position number to a first sequence of nucleic acids that corresponds to a first index region of the reference genome, wherein the size of the first index region is greater than or equal to the first minimum index region size;
assigning a second position number to a second sequence of nucleic acids that corresponds to a second index region of the reference genome, wherein the size of the second index region is greater than or equal to the first minimum index region size;
assigning a plurality of additional position numbers to a plurality of additional different sequences of nucleic acids each of which sequences corresponds to a respective index region of the reference genome; and
storing the associations of the position numbers to the respective index regions in a hash table.

2. The method of claim 1, wherein the second position is different than the first position.

3. The method of claim 1, wherein the second index region overlaps the first index region.

4. The method of claim 1, further comprising:
calculating a second minimum index region size based on the reference genome size, the second minimum index region size being shorter than the first minimum index region size;
assigning a third position number to a third index region of the reference genome, wherein the size of the third index region is greater than or equal to the second minimum index region size; and
storing the association of the third position number to the third index region, in the hash table.

5. The method of claim 1, wherein the reference genome has a total number of bases and the calculating a minimum index region size comprises taking the fourth log of the total number of bases in the reference genome.

6. A method for mapping a sequence read to a reference genome, comprising:
selecting a reference genome to index;
creating an indexing hash table that associates position numbers to each index region within the reference genome;
comparing a first sequence read against the index regions stored in the indexing hash table, to identify matches;
identifying all candidate locations on the reference genome that the first sequence read can be mapped against, wherein each candidate location contains at least two index regions that match corresponding regions on the first sequence read;
calculating a probability score for each of the identified candidate locations;
mapping the first sequence read to the candidate location with the highest probability score; and
aligning the first sequence read against the candidate location.

7. The method of claim 6, wherein the creating an indexing hash table comprises creating a table that: (1) associates a first set of position numbers to a first set of index regions within the reference genome; and (2) associates a second set of position numbers to a second set of index regions within the reference genome, wherein each index region of the second set of index regions has a length that is shorter than each index region of the first set of index regions.

8. The method of claim 7, further comprising:
comparing a second sequence read, shorter than the first sequence read, against the second set of index regions stored in the indexing hash table, to identify matches;
identifying all candidate locations on the reference genome that the second sequence read can be mapped against, wherein each candidate location contains at least two index regions that match corresponding regions on the second sequence read;
calculating a probability score for all identified candidate locations that the second sequence read can be mapped against;
mapping the second sequence read to the candidate location with the highest probability score; and
aligning the second sequence read against the candidate location.

9. The method of claim 6, further comprising:
identifying a second sequence read, the second sequence read comprising a plurality of k-mer reads of eight or less nucleic acid bases;
comparing the second sequence read against a wildcard indexing table; and
locating the second sequence read on the reference genome based on the comparing.

10. The method of claim 9, wherein:
the wildcard indexing table comprises a plurality of wildcard sequences; and
each of the plurality of wildcard sequences comprises a sequence of one to eight nucleic acid bases.

11. The method of claim 6, further comprising:
identifying an error in the first sequence read; and
fixing the error in the first sequence read.

12. The method of claim 11, wherein the identifying an error in the first sequence read comprises computing an expected coverage at a location on the reference genome and comparing the expected coverage to an average coverage.

13. The method of claim 10, further comprising:
identifying a likely error in the first sequence read;
identifying an error in the first sequence read that is the same or about the same as the identified likely error; and
fixing the error in the first sequence read, wherein the likely error in the first sequence read is determined using Poisson distribution.

14. A system for indexing a reference genome, comprising:
a memory for storing computer readable code;
a processor coupled to the memory, the processor being configured to:
select a reference genome to index;
calculate a first minimum index region size based on the reference genome size;
assign a first position number to a first sequence of nucleic acids that corresponds to a first index region of the reference genome, wherein the size of the first index region is greater than or equal to the first minimum index region size;
assign a second position number to a second sequence of nucleic acids that corresponds to a second index region of the reference genome, wherein the size of the second index region is greater than or equal to the first minimum index region size;
assign a plurality of additional position numbers to a plurality of different sequences of nucleic acids each of which sequences corresponds to a respective index region of the reference genome; and
store the associations of the position numbers to the respective index regions in a hash table.

15. The system of claim 14, wherein the processor comprises a hardware module.

16. The system of claim 14, wherein the processor is configured to:
calculate a second minimum index region size based on the reference genome size, the second minimum index region size being shorter than the first minimum index region size;
assign a third position number to a third index region of the reference genome, wherein the size of the third index region is greater than or equal to the second minimum index region size; and
store the association of the third position number to the third index region in the hash table.

17. The system of claim 14, wherein the processor is configured to calculate a minimum index region size by taking the fourth log of the total number of bases in the reference genome.

18. A system for mapping a sequence read to a reference genome, comprising:
a memory for storing computer readable code;
a processor coupled to the memory, the processor being configured to:
select a reference genome to index;
create an indexing hash table that associates position numbers to each index region within the reference genome;
compare a sequence read against the index regions stored on the indexing hash table, to identify matches;
identify all candidate locations on the reference genome that the sequence read can be mapped against, wherein each candidate location contains at least two index regions that match corresponding regions on the sequence read;
calculate a probability score for each of the identified candidate locations;
map the sequence read to the candidate location with the highest probability score; and
align the sequence read against the candidate location.

19. The system of claim 18, wherein the processor comprises a hardware module.

20. The system of claim 18, wherein the processor is configured to:
calculate a second minimum index region size based on the reference genome size, the second minimum index region size being shorter than the first minimum index region size;
compare a second sequence read against index regions of the second minimum index region size stored in the indexing hash table, to identify matches;
identify all candidate locations on the reference genome that the second sequence read can be mapped against, wherein each candidate location contains at least two index regions that match corresponding regions on the second sequence read;
calculate a probability score for each of the identified candidate locations that the second sequence read can be mapped against;
map the second sequence read to the candidate location, that the second sequence read can be mapped against, with the highest probability score; and
align the second sequence read against the candidate location.

21. The system of claim 20, wherein the processor is configured to calculate a minimum index region size by taking the fourth log of the total number of bases in the reference genome.

22. The system of claim 18, further comprising a gene sequencer having a signal output, wherein the processor comprises a signal input and the signal output of the gene sequencer is operatively connected to the signal input of the processor.
